(19) United States
(12) Patent Application Publication
(10) Pub. No.: US 2025/0100910 A1
(43) Pub. Date: Mar. 27, 2025

(54) REACTORS AND APPARATUS

(71) Applicant: National University of Singapore, Singapore (SG)

(72) Inventors: Olivier Lefebvre, Singapore (SG); Orlando Garcia Rodriguez, Singapore (SG); Ng Joyslin Tee, Singapore (SG); Weichen Qin, Singapore (SG); Yuling Dong, Singapore (SG)

(73) Assignee: National University of Singapore, Singapore (SG)

(21) Appl. No.: 18/891,803

(22) Filed: Sep. 20, 2024

(30) Foreign Application Priority Data
Sep. 22, 2023 (SG) 10202302694W

(51) Int. Cl. C02F 1/467; C02F 103/34

(52) U.S. Cl. CPC C02F 1/4672; C02F 2103/343; C02F 2201/002

(57) ABSTRACT

Disclosed herein are a reactor for removing a contaminant from a fluid, the reactor comprising a cathode comprising a sintered activated carbon filter, and an anode, and an apparatus for removing a contaminant from a fluid, the apparatus comprising at least one reactor as aforementioned, the inlet of the at least one reactor being in fluid communication with a fluid source containing one or more contaminants, a power supply connected to the cathode and anode, and a receptacle in fluid communication with the outlet of the one or more reactors. Also disclosed herein are a method of removing a contaminant from a fluid and use of a sintered activated carbon filter as defined herein for the removal of contaminant in a fluid in an electrochemical advanced oxidation process.

### FIELD OF INVENTION

The present invention relates to reactors and apparatus, and more particularly relates to reactors and apparatus for removing a contaminant from a fluid.

### BACKGROUND

The listing or discussion of a prior-published document in this specification should not necessarily be taken as an acknowledgement that the document is part of the state of the art or is common general knowledge.

Limiting antibiotic discharge into the environment is critically important to protect aquatic life and to help reduce the spread of antimicrobial resistance. Azithromycin (AZI, Table 1), a member of macrolide antibiotics, belongs to this group of contaminants of emerging concern. Owing to its extensive consumption, AZI is frequently introduced into domestic wastewater through the excretion of active compounds by individuals taking medication or through the improper disposal of unused medication. Concentrations of AZI in these effluents typically fall within the range of 10-900 ng L⁻¹. In pharmaceutical wastewater (PWW) originating from its manufacturing, AZI is even more of a problem because it is undiluted and its concentration can surge to several orders of magnitude higher, sometimes in excess of 150 mg L⁻¹. Even though in general active pharmaceutical ingredients are still insufficiently regulated globally, many pharmaceutical companies and organizations (e.g., the AMR Industry Alliance (AMRIA) and the Pharmaceutical Supply Chain Initiative) are proactively taking steps to anticipate stricter control of PWW discharge into the environment, owing to the risks of antibiotic resistance. Conventional biological treatment methods, such as activated sludge or anaerobic digestion, fall short of efficiently treating PWW, given its high toxicity and/or bio-recalcitrant nature. In the absence of a gold standard, incinerating PWW to remove antibiotics from wastewater is often used as a last resort but the energy and cost associated with it advocate for better solutions.

TABLE 1
AZI characteristics.

| | | | Molecular |
|---|---|---|---|
| | | Molecular | weight |
| Name | Chemical structure | formula | (g mol⁻¹) |
| Azithromycin | 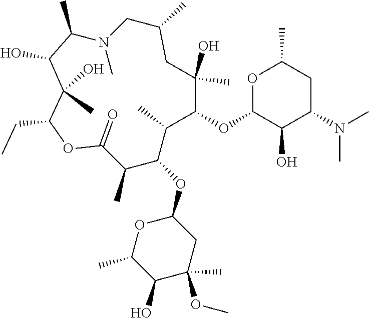 [SMILES: CC[C@H]1OC(=O)[C@H](C)[C@@H](O[C@H]2C[C@@](C)(OC)[C@@H](O)[C@H](C)O2)[C@H](C)[C@@H](O[C@@H]2O[C@H](C)C[C@H](N(C)C)[C@H]2O)[C@](C)(O)C[C@@H](C)CN(C)[C@H](C)[C@@H](O)[C@]1(C)O] | C₃₈H₇₂N₂O₁₂ | 749.0 |

Adsorption onto activated carbon (AC) constitutes another option for the removal of organic compounds from industrial effluents. Nevertheless, after adsorption, AC also requires further disposal or regeneration, which can be achieved by thermal or chemical methods. The former regeneration procedure is energy-inefficient and only allows a limited number of regeneration cycles, owing to the loss of properties. On the other hand, chemical regeneration involves solvent extraction, leading to the creation of secondary wastes, whose subsequent disposal and treatment increases the overall costs. Recently, AC regeneration by electrochemical processes has proven to be a cost-effective alternative that preserves the integrity of AC and does not generate secondary effluents. Among electrochemical regeneration methods, electro-Fenton (EF), an advanced oxidation process, has displayed promising results, with low energy consumption and high regeneration efficiency maintained over multiple cycles. The process is based on the use of carbonaceous materials to carry out the in-situ electrochemical reduction of O₂ via two electrons to produce H₂O₂(Eq. (1)) (Nidheesh, P. V. & Gandhimathi, R., Desalination 2012, 299, 1-15), which further reacts with Fe(II) to generate hydroxyl radicals (·OH) (Eq. (2)), a strong and non-selective oxidant able to mineralize organic pollutants in wastewater (Eq. (3)). Moreover, only catalytic amounts of Fe(II) are needed due to its continuous regeneration at the cathode (Eq. (4)), thus avoiding the generation of sludge.

$${O}_{2} + 2 {e}^{-} + 2 {H}^{+} \to {H}_{2} {O}_{2} \qquad ( 1 )$$

$${H}_{2} {O}_{2} + {Fe}^{2 +} \to {Fe}^{3 +} {+}^{-} OH {+}^{\cdot } OH \qquad ( 2 )$$

$$Pollutants {+}^{\cdot } OH \to {CO}_{2} + {H}_{2} O + Inorganic ions \qquad ( 3 )$$

$${Fe}^{3 +} + {e}^{-} \to {Fe}^{2 +} \qquad ( 4 )$$

Eq. (1) is favored on the surface of carbonaceous materials (Li, X. et al., Process Saf. Environ. Prot. 2023, 169, 186-198), making AC an excellent electrode material for EF. Furthermore, AC has the property to catalyze the decomposition of H₂O₂ into ·OH radicals and superoxide radicals via Eqs. (5) and (6) (Garcia-Rodriguez, O. et al., Carbon 2020, 163, 265-275), thus promoting its own regeneration without the need for acidification or addition of other chemicals and making the process even more efficient and attractive.

$$AC + {H}_{2} {O}_{2} \to A {C}^{+} {+}^{-} OH {+}^{\cdot } OH \qquad ( 5 )$$

$$A {C}^{+} + {H}_{2} {O}_{2} \to A C + {HO}_{2}^{\cdot } + {H}^{+} \qquad ( 6 )$$

Finally, the adsorption of pollutants onto AC brings them in close proximity with the electrogenerated oxidants, thereby enhancing mass transfer and facilitating their degradation and mineralization.

Most electrochemical regeneration studies have been conducted on granular activated carbon (GAC) with promising results. However, the electrical conductivity and distribution of potential in GAC is limited by its compression, which hinders its scale up and practical application. As reported by Zárate-Guzmán, A. I. et al., J. Electrochem. Soc. 2018, 165, E460, the lack of good compaction can decrease the conductivity of GAC up to 28 fold; yet, excessive GAC compaction can affect fluid circulation and compromise the electrochemical and/or adsorption processes. In addition, other regeneration methods based on high temperature cause AC structure degradation, thus limiting the number of regeneration cycles.

Therefore, to overcome at least one of the aforementioned problems, there exists a new for new reactors and apparatus for removing a contaminant from a fluid.

### SUMMARY OF INVENTION

Aspects and embodiments of the invention are provided in the following numbered clauses.
1. A reactor for removing a contaminant from a fluid, the reactor comprising: a cathode comprising a sintered activated carbon filter; and an anode.
2. The reactor of clause 1, wherein the cathode is configured to simultaneously function as a cathode and a filter.
3. The reactor of clause 1 or 2, wherein the anode is formed of boron doped diamond or a dimensionally stable anode (e.g. a dimensionally stable anode mesh).
4. The reactor of any preceding clause, further comprising a housing comprising an inlet and an outlet for the passage of a fluid through the reactor, wherein the cathode and anode are disposed within the housing.
5. The reactor of any clause 4, wherein the cathode and anode are fixed within the housing.
6. The reactor of any preceding clause, wherein at least one of the cathode and anode have a hollow cross section.
7. The reactor of any preceding clause, wherein at least one of the cathode and anode has tubular structure having an outer surface and an inner surface, the inner surface defining a lumen.
8. The reactor of clause 7, wherein the anode has a tubular structure having an outer surface and an inner surface, the inner surface defining a lumen, and the cathode is disposed within the lumen of the anode.
9. The reactor of clause 7, wherein the cathode has a tubular structure having an outer surface and an inner surface, the inner surface defining a lumen, and the anode is disposed within the lumen of the cathode.
10. The reactor of any preceding clause, wherein the anode and cathode each have a substantially circular cross section.
11. The reactor of any preceding clause, wherein the cathode and anode are not in physical contact with each other.
12. The reactor of any preceding clause, wherein the cathode and anode are physically separated from each other by a distance of from about 0.1 cm to about 5 cm, for example about 2 cm.
13. The reactor of any preceding clause wherein the sintered activated carbon filter has an average pore size of from about 0.1 μm to about 3 μm.
14. The reactor of any preceding clause, wherein the sintered activated carbon filter has a bimodal distribution of pore width, with micropores having a pore width of from about 0.5 nm to about 1.5 nm and mesopores have a pore width of from about 2 nm to about 15 nm.
15. The reactor of any preceding clause, wherein the sintered activated carbon filter has a surface area of at least about 200 m²/g⁻¹ (BET), for example about 2000 m²/g⁻¹ (BET) or more.
16. The reactor of any preceding clause, wherein the sintered activated carbon filter has an average pore volume of from about 0.2 cm³ g⁻¹ to about 0.4 cm³ g⁻¹.
17. The reactor of any preceding clause, wherein the anode and cathode are each electrically connectable to a power source.
18. An apparatus for removing a contaminant from a fluid, the apparatus comprising at least one reactor according to any one of clauses 1 to 17, the inlet of the at least one reactor being in fluid communication with a fluid source containing one or more contaminants, a power supply connected to the cathode and anode, and a receptacle in fluid communication with the outlet of the one or more reactors.
19. The apparatus of clause 18, wherein the fluid source is a water source, for example, a wastewater source.
20. The apparatus of clause 18, wherein the fluid source is a gas source, for example, an air source.
21. The apparatus of any one of clauses 18-20, wherein the one or more contaminants are selected from the group consisting of an organic compound, an inorganic compound, a heavy metal (e.g. mercury, lead, chromium, cadmium, and arsenic), and a pathogen (e.g. a viral particle, bacterium, fungus or protozoan).
22. A method of removing a contaminant from a fluid, said method comprising
   supplying the apparatus of any one of clauses 18-21 with a fluid comprising at least one contaminant such that the fluid enters through an inlet of the at least one reactor and is subjected to an electrochemical advanced oxidation process to remove the contaminant, such that the fluid passing through an outlet of the one or more reactors is a decontaminated fluid that has substantially none of the at least one contaminant present.
23. The method according to clause 22, wherein the at least one contaminant is adsorbed on to the sintered activated carbon filter and undergoes electrochemical treatment.
24. The method according to clause 22 or 23, wherein the fluid comprising at least one contaminant is continuously supplied to the apparatus.
25. The method according to any one of clauses 22-24, wherein the sintered activated carbon filter is continuously regenerated by the electrochemical advanced oxidation process.
26. The method according to any one of clauses 22-25, wherein the fluid is wastewater, and the at least one contaminant is an organic compound, inorganic compounds, heavy metals (e.g. mercury, lead, chromium, cadmium, and arsenic), or a pathogen (e.g. viral particles, bacteria, fungi or protozoa).
27. The method according to any one of clauses 22-26, wherein the method does not comprise a step of adding an electrolyte to the fluid comprising at least one contaminant.
28. The method according to any one of clauses 22-26, wherein the method comprises adding potassium sulphate, iron (II) sulfate, or a mixture thereof to the fluid comprising at least one contaminant.
29. The method according to any one of clauses 22-28, wherein the fluid is continuously supplied to the apparatus at a flow rate of from about 5 mL/min to about 40 mL/min, such as from about 8 mL/min to about 14 mL/min (e.g. about from 8 mL/min to about 10 mL/min).
30. The method according to any one of clauses 22-29, wherein the electric potential applied to the cathode and anode is from about 3V to about 6V, for example, from about 4V to about 6V (e.g. about 4.4V, about 4.9V, and about 5.4V).
31. The method according to any one of clauses 22-30, wherein the electrochemical advanced oxidation process is an electro-Fenton process.
32. The method according to any one of clauses 22-31, wherein the electrochemical regeneration cycle of the regeneration step is conducted for a period of from about 10 seconds to about 180 minutes, such as about from 30 seconds to about 140 minutes, such as from about 60 to about 130 minutes, such as about 120 minutes.
33. Use of a sintered activated carbon filter as defined herein for the removal of contaminant in a fluid in an electrochemical advanced oxidation process.

### DRAWINGS

FIG. 1 depicts an experimental setup.

FIG. 2 depicts (a) total organic carbon (TOC) removal over time at various applied potentials (pH=3, 50 mM K₂SO₄, 0.2 mM Fe(II)), and (b) TOC removal after 5 h under different operational conditions.

FIG. 3 depicts the evolution of soluble and insoluble iron concentrations during electrochemical treatment (condition III).

FIG. 4 depicts (a) plot of linearized form of mineralization pseudo-first-order (MPFO) and mineralization pseudo-second-order (MPSO) under condition (III) and; (b) plot of linearized form of adsorption pseudo-second order (APSO) under condition (III) and control (open circuit).

FIG. 5 depicts (a) TOC removal, and (b) sintered activated carbon (SAC) maximum adsorption capacity over ten consecutive treatment cycles of 5 h each. Fe (II) in catalytic amounts was added at the beginning of each cycle.

FIG. 6 depicts the effect of the treatment time on the TOC removal efficiency.

FIG. 7 depicts the schematic drawing summarizing the mechanisms of pollutant adsorption, mineralization, and SAC regeneration.

FIG. 8 depicts chromatograms of (a) carboxylic acids and (b) azithromycin evolution over time during the electrochemical treatment (Condition III).

FIG. 9 depicts (a) peak area evolution of identified carboxylic acids and (b) azithromycin removal over time during electrochemical treatment (Condition III).

FIG. 10 depicts scanning electron microscopy (SEM) image of (a) unused SAC and (b) SAC after treatment.

FIG. 11 depicts SEM with energy-dispersive X-ray spectroscopy analysis of SAC (a) before and (b) after electrochemical regeneration.

FIG. 12 depicts (a) adsorption/desorption isotherms of N₂ at 77K and (b) pore size distribution of SAC before and after electrochemical treatment. (c) Nyquist plot of electrochemical impedance spectroscopy (EIS) & (d) equivalent circuit (e) Raman spectrum and (f) XRD of unused SAC and SAC after PWW treatment.

FIG. 13 depicts (a) EC_{TOC} and (b) EC_{VOL} over time under Condition (III).

FIG. 14 depicts a hydroponics system.

FIG. 15 depicts another experimental setup.

FIG. 16 depicts coliform removal efficiency.

FIG. 17 depicts phosphate with various electrode pairs.

FIG. 18 depicts nitrogen species under various potentials with AC-DSA.

### DESCRIPTION

It has been surprisingly found that the reactors and apparatus disclosed herein provide a sustainable approach for treating hard-to-treat effluents. Without wishing to be bound by theory, the reactors and apparatus disclosed herein allow in-situ electrochemical regeneration of sintered activated carbon (SAC, which act both as an adsorption filter and as an electrode in the reactors and apparatus disclosed herein) to take place simultaneously as the treatment of effluents, thus enhancing their performance and ensuring their stable operation over time, while eliminating cleaning downtimes altogether.

Thus, in a first aspect of the invention, there is provided a reactor for removing a contaminant from a fluid, the reactor comprising:
a cathode comprising a sintered activated carbon filter; and
an anode.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

As used herein, the singular forms “a,” “an,” and “the” include plural referents unless the context clearly dictates otherwise. The term “plurality” as used herein means two or more.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

Any suitable material may be used as the cathode. For example, the anode may be formed from carbon-fibre brush, activated carbon, or sintered activated carbon. In certain embodiments, the cathode may be formed of a sintered activated carbon.

Any suitable size of the cathode may be used. For example, the cathode may have an effective geometrical area immersed in the fluid of 128 cm².

Any suitable material may be used as the anode. For example, the anode may be formed from boron doped diamond or dimensionally stable anode mesh. In certain embodiments, the anode may be formed of a dimensionally stable anode mesh.

Any suitable size of the anode may be used. For example, the anode may have an effective geometrical area immersed in the fluid of 216 cm².

In certain embodiments of the first aspect of the invention, the cathode may be configured to simultaneously function as a cathode and a filter. Without wishing to be bound by theory, this would allow in-situelectrochemical regeneration and removal of the contaminant from the fluid to take place simultaneously, thus enhancing the performance of the reactor and ensuring its stable operation over time, while eliminating cleaning downtimes altogether.

In certain embodiments of the first aspect of the invention, the reactor may further comprise a housing comprising an inlet and an outlet for the passage of a fluid through the reactor, wherein the cathode and anode are disposed within the housing. In such embodiments, the cathode and anode may be fixed within the housing.

In certain embodiments of the first aspect of the invention, at least one of the cathode and anode may have a hollow cross section. In such embodiments, at least one of the cathode and anode may have tubular structure having an outer surface and an inner surface, the inner surface defining a lumen. In one embodiment, the anode may have a tubular structure having an outer surface and an inner surface, the inner surface defining a lumen, and the cathode is disposed within the lumen of the anode. In another embodiment, the cathode may have a tubular structure having an outer surface and an inner surface, the inner surface defining a lumen, and the anode is disposed within the lumen of the cathode.

In certain embodiments of the first aspect of the invention, the anode and cathode may each have a substantially circular cross section.

In certain embodiments of the first aspect of the invention, the cathode and anode may be not in physical contact with each other. The cathode and anode may be physically separated from each other by any suitable distance. For example, the cathode and anode may be physically separated from each other by a distance of from about 0.1 cm to about 5 cm. For example, the cathode and anode may be physically separated from each other by a distance of about 2 cm.

Any suitable average pore size may be used for the sintered activated carbon filter. In certain embodiments of the first aspect of the invention, the sintered activated carbon filter may have an average pore size of from about 0.1 μm to about 3 μm. Any suitable method may be used to measure the average pore size. For example, the average pore size of materials disclosed herein may be determined using scanning electron microscopy.

In certain embodiments of the first aspect of the invention, the sintered activated carbon filter may have a bimodal distribution of pore width, with micropores having a pore width of from about 0.5 nm to about 1.5 nm and mesopores may have a pore width of from about 2 nm to about 15 nm. In further embodiments, the micropores may have a pore width of from about 0.55 nm to 1.33 nm. In further embodiments, the mesopores may have a pore width of from about 2.6 nm to about 10 nm.

In certain embodiments of the first aspect of the invention, the sintered activated carbon filter may have a surface area of at least about 200 m²/g⁻¹ (BET). For example, the sintered activated carbon filter may have a surface area of at least about 2000 m²/g⁻¹ (BET) or more.

The surface area of materials disclosed herein may be determined from nitrogen adsorption data using the Brunauer-Emmett-Teller (BET) method. See Brunauer, S. et al., J. Am. Chem. Soc. 1938, 60, 309-331, which is incorporated herein by reference.

Any suitable pore volume may be used for the sintered activated carbon filter. In certain embodiments, the sintered activated carbon filter may have an average pore volume of from about 0.2 cm³ g⁻¹ to about 0.4 cm³ g⁻¹. In further embodiments, the sintered activated carbon filter may have an average pore volume of from about 0.227 cm³ g⁻¹ to about 0.256 cm³ g⁻¹.

In certain embodiments of the first aspect of the invention, the anode and cathode may be each electrically connectable to a power source.

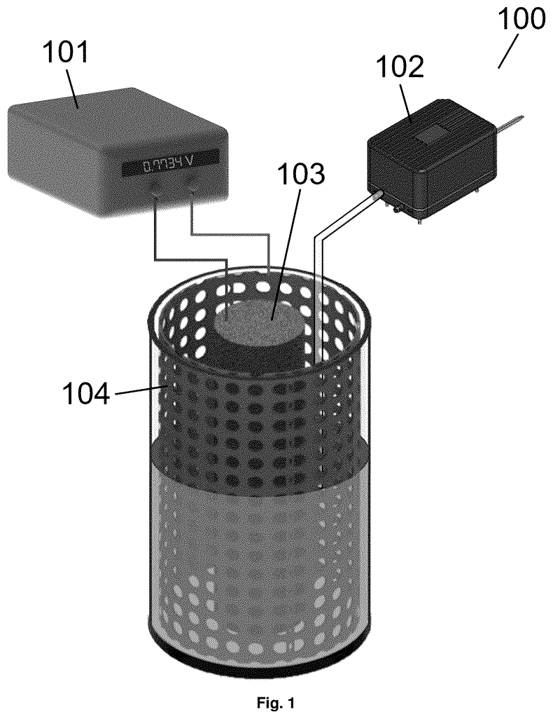

FIG. 1 illustrates an electrochemical setup in accordance with embodiments of the current invention. As shown in FIG. 1, the electrochemical setup 100 may include a power supply 101, an air pump 102, a SAC cathode 103, and a DSA anode 104. Each of the SAC cathode 103 and the DSA anode 104 may be connected to the power supply 101.

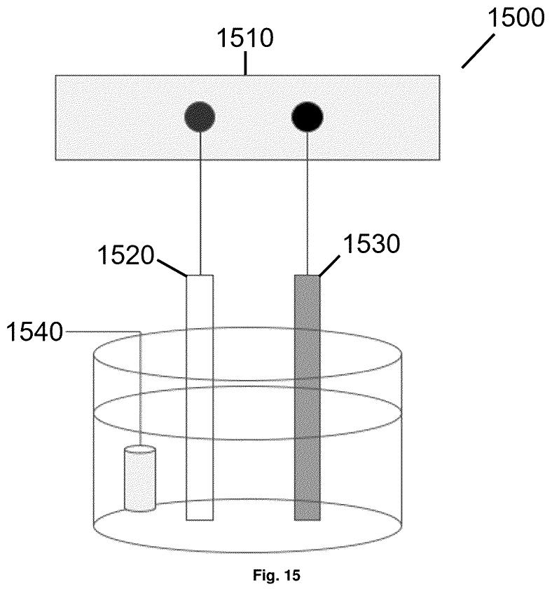

FIG. 15 illustrates another electrochemical setup in accordance with embodiments of the current invention. As shown in FIG. 15, the electrochemical setup 1500 may includes a power supply 1510, an anode 1520, a cathode 1530, and an air supply 1540. Each of the anode 1520 and the cathode 1530 may be connected to the power supply 1510.

As will be appreciated, the current invention may relate to any fluid that contains a waste product/contaminate suitable to be treated by the methods disclosed herein. For example, the fluid may be water, for example a domestic wastewater or, more particularly, the wastewater may be an industrial wastewater. Examples of domestic and industrial wastewaters that may be mentioned herein may be ones in which the contaminant may be an organic compound. The fluid may be a gas, for example, air comprising one or more contaminates, such as pollutants.

In a second aspect of the invention, there is provided an apparatus for removing a contaminant from a fluid, the apparatus comprising at least one reactor according to the first aspect of the invention, the inlet of the at least one reactor being in fluid communication with a fluid source containing one or more contaminants, a power supply connected to the cathode and anode, and a receptacle in fluid communication with the outlet of the one or more reactors.

In certain embodiments of the second aspect of the invention, the fluid source may be a water source. For example, the fluid source may be a wastewater source.

In certain embodiments of the second aspect of the invention, the fluid source may be a gas source. For example, the fluid source may be an air source.

Any suitable power source may be used in the reactor and apparatus disclosed herein.

The reactor and apparatus disclosed herein are suitable for performing an electrochemical advanced oxidation process to remove a contaminant from a fluid, such as wastewater (e.g. pharmaceutical wastewater).

In certain embodiments of the second aspect of the invention, the one or more contaminants may be an organic compound, an inorganic compound, a heavy metal (e.g. mercury, lead, chromium, cadmium, and arsenic), or a pathogen (e.g. a viral particle, bacterium, fungus or protozoan).

When used herein, the term “substantially none” is intended to refer to a reduction of the at least contaminant that is at least a 95% reduction, such as at least a 96.5% reduction, such as at least a 97% reduction, such as at least a 99% reduction, such as at least a 99.5% reduction, such as at least a 99.9% reduction, such as a 100% reduction of the contaminant compared to the original value within the fluid.

Any suitable flow rate of the fluid may be used in the method described above. For example, when the fluid is water, the water may be continuously supplied to the apparatus at a flow rate of from about 5 to about 40 mL/min, such as from about 8 to about 14 ml/min, such as from about 8 to about 10 mL/min.

As will be appreciated, the exact flow rate of the fluid may be changed to match the dimensions of reactor.

Any suitable current may be used to conduct the electrochemical advanced oxidation process. For example, the current may be from 1 to 30 mA/g, such as from 10 to 25 mA/g, such as from 15 to 18 mA/g, such as 16.6 mA/g. In embodiments of the invention, the electrochemical advanced oxidation process may be an electro-Fenton process.

As noted, the apparatus of the present invention may be regenerated. This occurs simultaneously to the adsorption of the at least one contaminate to the cathode by electrochemical treatment of the contaminant on the cathode. This is believed to occur through the in-situ electrochemical reduction of O₂ on the cathode to produce H₂O₂, which further reacts with Fe(II) to generate hydroxyl radicals (·OH), a strong and non-selective oxidant able to mineralize organic pollutants. Moreover, only catalytic amounts of Fe(II) are needed due to continuous regeneration at the cathode, thus avoiding the generation of sludge and therefore prolonging the performance of the reactor.

In a third aspect of the invention, there is provided a method of removing a contaminant from a fluid, said method comprising
supplying the apparatus according to the second aspect of the invention with a fluid comprising at least one contaminant such that the fluid enters through an inlet of the at least one reactor and is subjected to an electrochemical advanced oxidation process to remove the contaminant, such that the fluid passing through an outlet of the one or more reactors is a decontaminated fluid that has substantially none of the at least one contaminant present.

In certain embodiments of the third aspect of the invention, the at least one contaminant may be adsorbed on to the sintered activated carbon filter and undergoes electrochemical treatment.

In certain embodiments of the third aspect of the invention, the fluid comprising at least one contaminant may be continuously supplied to the apparatus.

In certain embodiments of the third aspect of the invention, the sintered activated carbon filter may be continuously regenerated by the electrochemical advanced oxidation process.

In certain embodiments of the third aspect of the invention, the fluid may be wastewater, and the at least one contaminant may be an organic compound, inorganic compounds, heavy metals (e.g. mercury, lead, chromium, cadmium, and arsenic), or a pathogen (e.g. viral particles, bacteria, fungi or protozoa).

In certain embodiments of the third aspect of the invention, the method may not comprise a step of adding an electrolyte to the fluid comprising at least one contaminant.

In certain embodiments of the third aspect of the invention, the method may comprise adding potassium sulphate, iron (II) sulfate, or a mixture thereof to the fluid comprising at least one contaminant.

In certain embodiments of the third aspect of the invention, the fluid may be continuously supplied to the apparatus at a flow rate of from about 5 mL/min to about 40 mL/min, such as from about 5 mL/min to about 14 mL/min, such as from about 5 mL/min to about 10 mL/min, such as from about 5 mL/min to about 8 mL/min, such as from about 8 mL/min to about 40 mL/min, such as from about 10 mL/min to about 40 mL/min, such as from about 10 mL/min to about 14 mL/min, such as from about 14 mL/min to about 40 mL/min, such as from about 8 mL/min to about 14 mL/min (e.g. about from 8 mL/min to about 10 mL/min).

In certain embodiments of the third aspect of the invention, the electric potential applied to the cathode and anode may be from about 3V to about 6V. For example, the electric potential applied to the cathode and anode may be from about 4V to about 6V (e.g. about 4.4V, about 4.9V, and about 5.4V).

In certain embodiments of the third aspect of the invention, the electrochemical advanced oxidation process may be an electro-Fenton process.

In certain embodiments of the third aspect of the invention, the electrochemical regeneration cycle of the regeneration step may be conducted for a period of from about 10 seconds to about 180 minutes, such as about from 30 seconds to about 140 minutes, such as from about 60 to about 130 minutes, such as about 120 minutes.

The method described herein may be conducted as many times as possible—that is, up to the point where the sintered activated carbon has been exhausted. For example, the method may be conducted from 10 to 10,000 times, such as from 10 to 500 times, such as from 10 to 100 times, such as 10 times. When used herein, “exhausted” may take its normal meaning in the art. Additionally or alternatively, the term “exhausted” when used herein may refer to the point where the sintered activated carbon cannot be regenerated to provide a desired level of adsorption anymore.

In a fourth aspect of the invention, there is provided a use of a sintered activated carbon filter as defined herein for the removal of contaminant in a fluid in an electrochemical advanced oxidation process.

The use of a sintered activated carbon filter as defined herein for the removal of contaminant in a fluid in an electrochemical advanced oxidation process may be demonstrated by Fang, C. et al., Water Res. 2024, 259, 121832, which is incorporated herein by reference.

As will be appreciated, the present invention may provide the following advantages:
the method disclosed herein is softer on the AC and improves the properties of AC by acting as a cleaning agent;
no need for pre-conditioning (no electrolyte added, as well as no acid and/or base). This may expand the application of the present invention to treating low concentration effluents for which it would be unrealistic to add chemicals. In general, the present invention may reduce the cost of treatment of contaminated fluids and simplify the treatment process.
application of SAC to a real pharmaceutical effluent with high concentration of Azithromycin (AZI); and
an alternative to incineration, which could result in significant cost savings for pharmaceutical companies and other industrial sectors facing the challenge of high-load and hard-to-treat wastewater (e.g. in the chemical or electronics sectors).

Further aspects and embodiments of the invention will now be discussed by reference to the following non-limiting examples.

### EXAMPLES

### Reading Key:

Red—Prof Olivier_Dr Loh Wei Hao
Green—IDF—edited, 22 Sep. 2023

### Materials

The pharmaceutical wastewater resulting from the production of azithromycin was procured from Pfizer (Singapore), kept in polyethene containers and stored at 4° C. (Table 2). A Millipore® Milli-Q system (1×0.2 M cm resistivity at 25° C.) was used to produce deionized water for all solution preparations. Potassium sulfate (K₂SO₄, ≥99%), iron (II) sulfate heptahydrate (FeSO₄·7H₂O, ≥99.5%), potassium dihydrogen phosphate (KH₂PO₄≥99%), sodium hydroxide (NaOH, ≥98%) and, sulfuric acid (H₂SO₄, 95-98%) were sourced as reagent grade. Acetonitrile (CH₃CN≥99.9%) and azithromycin dihydrate (C₃₈H₇₂N₂O₁₂·2H₂O, ≥99%) were procured as HPLC grade. All chemicals were purchased from Sigma-Aldrich/Merck (Singapore).

TABLE 2
Characterization of the real pharmaceutical wastewater
(PWW) used in the present disclosure.

| | | | | AZI |
|---|---|---|---|---|
| | | | | concentration |
| pH | Conductivity | TOC (mg L⁻¹) | IC (mg L⁻¹) | (mg L⁻¹) |
| 8.5-9.1 | 348 μS cm⁻¹ | 1629.0 | 14.5 | 12.5 |
| | | (±255.7) | (±1.4) | |

### Example 1. Electrochemical Experiments Setup

Electrochemical experiments were performed in an undivided electrolytic cell with a working volume of 300 mL. The electrochemical setup, illustrated in FIG. 1, features a dimensionally stable anode (DSA) mesh with cylindrical shape coated with Ir—Ru (Baoji Ruicheng, China) serving as anode and a SAC cylinder (Mihasga, China) cathode made from coconut shell, with an effective geometrical area immersed in the PWW of 216 cm² and 128 cm², respectively. DSA and SAC were used as is and arranged concentrically with a 2 cm gap in between and connected to a power supply (Rohde & Schwarz HMP4030, Germany). Whenever required, 50 mM K₂SO₄ electrolyte and 0.2 mM iron (II) catalyst were used. As shown in FIG. 1, the electrochemical setup 100 includes a power supply 101, an air pump 102, a SAC cathode 103, and a DSA anode 104. The pH was adjusted with concentrated H₂SO₄ and compressed air or nitrogen was sparged at a flow rate of 0.2 L min⁻¹, starting 25 min prior to electrolysis and provided until the end of the experiment in order to maintain an oxygen-saturated or oxygen-depleted environment, respectively. All experiments were carried out with a constant applied potential ranging from 3.9 to 5.9 V during the optimization phase, followed by a fixed potential of 4.4 V after optimization. All experiments were conducted in duplicate for each set of conditions at a constant room temperature of 25° C. Data were assessed statistically by Student's t-tests for unpaired samples. Two sets of data were considered significantly different when the P value was inferior than 0.05.

The electrochemical set up was operated in different conditions, as well as a control set up, with specification shown in Table 3.

TABLE 3
Operational parameter conditions.

| Conditions | Operational parameters |
|---|---|
| Control | PWW, open circuit |
| I | PWW continuously sparged with N₂ |
| II | PWW continuously sparged with O₂ |
| III | PWW with addition of 0.2 mM of Fe(II) |
| IV | PWW pre-conditioned with optimal parameters for |
| | EF process (Brillas, E., Sci. Total Environ. 2022, 819, |
| | 153102): pH 3, 50 mM K₂SO₄ and 0.2 mM Fe(II) |

### Example 2. Analysis and Characterization of PWW and SAC

### Total Organic Carbon (TOC) Measurements

TOC measurements were performed in a Shimadzu TOC-VCSH analyzer (Japan). The method employed for the identification of short-chain carboxylic acids and azithromycin relied on ion-exclusion high-performance liquid chromatography (HPLC), using an Agilent 1200 series instrument (USA) equipped with a UV detector. To achieve optimal separation and detection of carboxylic acids, a specific chromatographic column, namely Aminex HPX-87H (300×7.8 mm, 9 μm), was utilized. The mobile phase consisted of 0.008 N sulfuric acid (H₂SO₄), and the flow rate was maintained at 0.600 mL min⁻¹ with UV detector set at 212 nm. For the identification of AZI, a different chromatographic column, Agilent ZORBAX Extend-C18 (150 mm×2.10 mm, 5 μm), was employed. The mobile phase composition for this analysis comprised an isocratic blend of pure acetonitrile and a pH 6 phosphate buffer (prepared following a method described elsewhere (Ghari, T. et al., Iran. J. Pharm. Res. IJPR 2013, 12, 57-63) at a ratio of 50:50 (v/v), with a consistent flow rate maintained at 0.250 mL min⁻¹. Detection was achieved at a wavelength of 254 nm. Both columns were maintained at a constant temperature of 30° C., and a precise sample volume of 20 μL was injected in all cases.

### Soluble and Insoluble Iron Concentration Measurements

Soluble and insoluble iron concentrations in the solution were determined by acidification of the sample before and after filtration, respectively, followed by quantification in an Agilent 5110 Inductively Coupled Plasma Optical Emission Spectroscopy (ICP-OES) analyzer (USA) with an Agilent SPS 4 Autosampler (USA) at an emission spectrum of 238 nm wavelength. The adsorbed iron value is calculated as:

$${Fe}_{adsorbed} = {Fe}_{initial} - ( {Fe}_{dissolved} + {Fe}_{insoluble} ) \qquad ( 7 )$$

where all terms are in ppm (mg L⁻¹).

SAC was characterized by scanning electron microscopy (SEM, Zeiss Supra 40, Germany) coupled with energy-dispersive X-ray spectroscopy (EDX, Oxford Ultimax 65, England) to elucidate the morphology and elemental composition of SAC. The specific surface area and porosity of SAC were determined by Brunauer-Emmett-Teller analysis (BET) analysis from the isotherms of nitrogen adsorption/desorption at 77K (Autosorb iQ, Quantachrome, USA) (Parra, J. B. et al., Adsorpt. Sci. Technol. 1995, 12, 51-66).

### Electrochemical Impedance Spectroscopy (EIS)

EIS was conducted in a three-electrode cell set up, utilizing an Autolab PGSTAT204 with FRA32M EIS module (Metrohm Ltd in Switzerland). The reference and counter electrodes used were Ag/AgCl and DSA, respectively.

### Raman Analysis

Raman analysis was conducted in a Modular Raman Spectrometer (Horiba, Japan). The argon-ion laser power and wavelength at the sample surface was controlled at about 50 mW and 514 nm, respectively. The system was calibrated using a silicon reference before the measurement (520.5 cm⁻¹). During the measurement, the sample was dispersed in the deionized water.

### X-Ray Diffraction Spectroscopy (XRD)

XRD was carried out in a Bruker-AXS D8 Advanced X-ray diffractometer system (Bruker, Germany) with Cu Kα (λ=1.5406 Å) radiation. A dried sample of the activated carbon electrode was prepared and tested at 40 kV and 30 mA. Scans were recorded in the 2θ angle range of 20-70° with a step size of 0.040°. The spectra were extracted with Profex software and plotted with Origin software.

### Example 3. Optimization of Applied Potential and Effect of Conditioning

The optimization of the applied potential is a key aspect of EF that significantly affects its efficiency due to the many reaction pathways that may take place. Additionally, the magnitude of the current generated during electrochemical treatment is contingent upon both the composition of the wastewater and the applied potential. Although higher current densities can enhance the process efficiency, they can also intensify the occurrence of side reactions that produce unwanted by-products, ultimately impacting the rate at which hydroxyl radicals (·OH) and other oxidizing agents are generated. It is thus crucial to identify the ideal applied potential that will enable the production of desired products, while minimizing parasitic reactions.

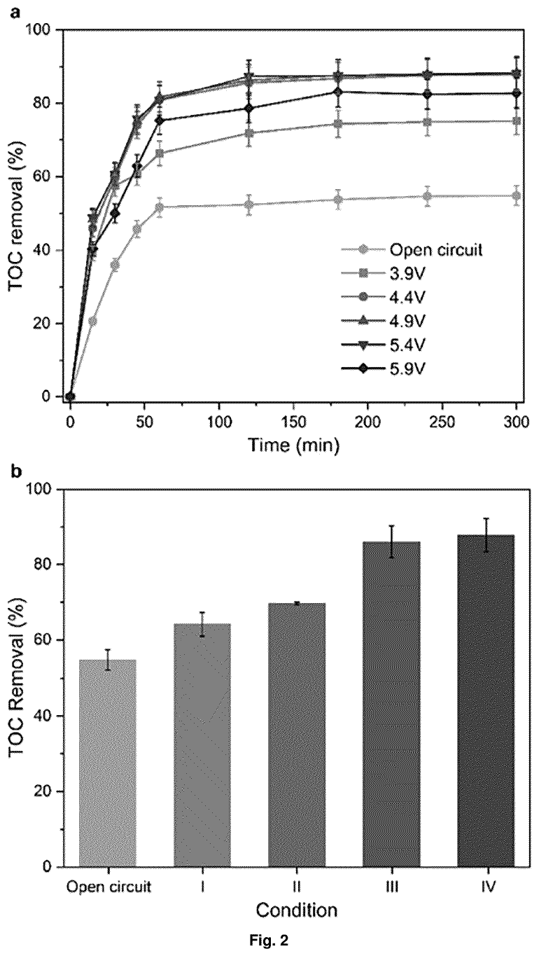

FIG. 2a shows the TOC removal over time at various applied potentials alongside a control in open circuit. In all cases, the shape of the curves is similar with a sharp increase followed by a plateau after 120 to 180 min (P>0.05; Student's t-test). Upon increasing the potential up to 4.4 V, a significant enhancement in TOC removal was observed from 55% (open circuit) to 88% after 300 min of treatment. Further increase to 4.9 V and 5.4 V did not yield any additional enhancement in TOC removal efficiency and, on the contrary, a decrease in efficiency was observed at the highest applied potential of 5.9 V, leading to a lower TOC removal of 83%. This suggests that parasitic reactions, such as hydrogen evolution (Eq. (8)) and oxygen reduction via four electrons (Eq. (9)) at the cathode, as well as oxygen evolution (Eq. (10)) at the anode started to predominate (Ganiyu, S. O. et al., Appl. Catal. B Environ. 2018, 235, 103-129; and Sopaj, F. et al., Appl. Catal. B Environ. 2016, 199, 331-341). Therefore, 4.4 V was determined to be the optimal applied potential for the electrochemical treatment of AZI PWW and it was used as the operating potential in the following examples.

$$2 {H}^{+} + 2 {e}^{-} \to {H}_{2} \qquad ( 8 )$$

$${O}_{2} + 4 {e}^{-} + 4 {H}^{+} \to 2 {H}_{2} O \qquad ( 9 )$$

$$2 {H}_{2} O \to {O}_{2} + 4 {e}^{-} + 4 {H}^{+} \qquad ( 10 )$$

### Example 4. Effect of Conditioning

Besides applied potential, previous studies have highlighted the importance of optimizing pH and electrolyte concentration to improve mineralization efficiencies in EF systems. The body of work on optimizing pH for EF is abundant and has consistently designated a pH close to 3 as being optimal, above which, pollutant decomposition rates decrease due to the reduced oxidation potential of OH radicals and limited solubility of iron. Furthermore, multiple studies have underscored the significance of an electrolyte concentration of 50 mM for optimal conductivity in the electro-Fenton process. The concentration of ferrous ions is usually maintained at approximately 0.2 mM, as it has been reported that concentrations exceeding this level may result in parasitic reactions involving ·OH radicals that reduce the efficiency of the process.

However, the optimization of these parameters requires additional chemicals, in turn leading to an increase in treatment costs that may hamper practical applications (Garcia-Segura, S. et al., Curr. Opin. Electrochem. 2020, 22, 9-16). In this example, we evaluated the electrochemical process under 4 conditions labelled from I to IV as shown in Table 3, as well as a control experiment in open circuit.

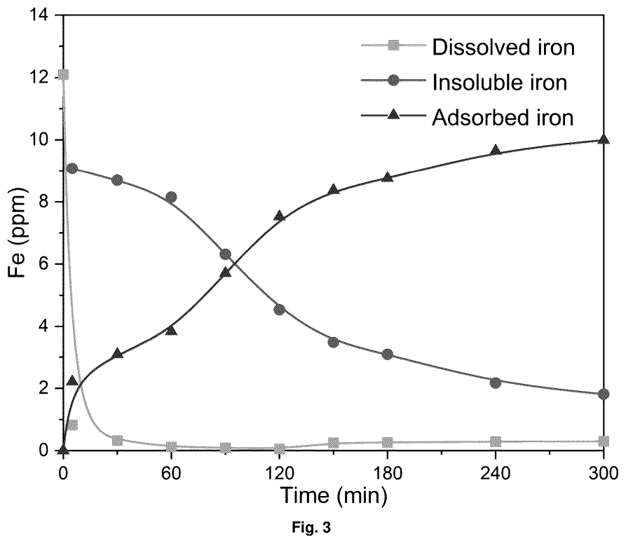

The control experiment displayed the lowest removal efficiency among all conditions tested; nevertheless, under open circuit potential where adsorption was the only possible removal process, the setup was still able to remove about 54% of the organic compounds (FIG. 2b). By closing the circuit and sparging PWW with N₂ gas (condition I), an increase in TOC removal efficiency by approximately 10% was observed, which could be ascribed to electro-adsorption (i.e., elimination of charged organic compounds by the electric field generated by the polarized electrodes (dos Reis da Costa, J. G. et al., J. Environ. Chem. Eng. 2021, 9, 106355). Another possible mechanism under condition (I) consists of direct electron transfer at the DSA electrode; yet, being an active anode, the oxidation efficiency of the chemisorbed hydroxyl radicals produced is expected to be low. Condition (II) added the contribution of cathodic H₂O₂ generation in addition to the processes occurring in condition (I). The higher TOC removal efficiency of 70% observed under condition (II) demonstrates that H₂O₂ also contributed to the removal efficiency of TOC, either through direct oxidation of organic pollutants or via the indirect generation of ·OH within the SAC as outlined in Eqs. (5) and (6) (Bañuelos, J. A. et al., J. Electrochem. Soc. 2015, 162, E154). Lastly, comparable TOC removal efficiencies were observed under conditions (III) (86%±4.3%) and (IV) (87%±4.4%), (P>0.05; Student's t-test). This is despite the differences in initial pH and conductivity between both conditions. The excellent performance obtained under both conditions showcased that the conductivity in the raw PWW was sufficient to sustain an efficient electrochemical process and also highlighted the crucial role of iron in enhancing the treatment efficiency even under alkaline pH of ˜9 (the natural pH of the real PWW used in the present disclosure, which was unaltered under condition III). FIG. 3 shows the evolution of soluble, insoluble and adsorbed iron during the electrolysis in condition (III), evidencing that about 83% (10 mg L⁻¹) of the iron initially present in solution was adsorbed onto the SAC after 300 min. This could not only facilitate the electro-regeneration of Fe(III) to Fe(II) (Eq. (4)), but also increase the production of ·OH by bringing Fe(II) in immediate vicinity to the in-situ electro-generated H₂O₂. As a result, this phenomenon facilitated the degradation of organic compounds present in PWW, in turn liberating (or cleaning) the pores in SAC by means of pollutant mineralization. Since condition (III) displayed similar TOC removal efficiency as (IV), despite lack of conditioning with electrolyte and pH adjustments, condition (III) was selected as the optimal condition and retained for the remaining experiments.

### Example 5. Kinetic Modelling of TOC Removal by SAC

It is clear that TOC removal resulted from 2 main processes: (i) electrochemical mineralization; and (ii) adsorption/electro-adsorption. Therefore, the kinetic modelling of the whole process might prove challenging due to the fact that each of these processes has its own set of parameters and rate equations. Hence, the removal of TOC was analyzed under the optimal condition (III) through kinetic modelling of both processes. In order to gain a deeper understanding of the predominant mechanisms, the data were fitted to widely used kinetic models for electrochemical mineralization and adsorption, as shown in Table 4.

TABLE 4
Kinetic models for direct EF mineralization and adsorption and relevant parameters.

| | | Linearized | | qₑ | | |
|---|---|---|---|---|---|---|
| Process | Kinetic model | form | Condition | (mg g⁻¹) | Rate constant | r² |
| *Electrochemical mineralization | Mineralization pseudo-first- | $ln \frac{[ {C}_{0} ]}{[ {C}_{t} ]} = {k}_{1} t$ | III | N.A. | k₁ = 0.003 min⁻¹ | 0.63 |
| | order (MPFO) | | | | | |
| | Mineralization pseudo- | $\frac{1}{{C}_{𝔱}} = {k}_{2} t$ | III | N.A. | k₂ = 2 × 10⁻⁷ L mg⁻¹ min⁻¹ | 0.73 |
| | second-order | | | | | |
| | (MPSO) | | | | | |
| **Adsorption | Adsorption pseudo- | $\frac{t}{{q}_{t}} = \frac{1}{{k}_{a d s 2} {q}_{e}^{2}} + \frac{1}{{q}_{e}} t$ | III | 10.31 | k_{ads2} = 0.004 g mg⁻¹ min⁻¹ | 0.99 |
| | second order | | Control | 6.84 | k_{ads2} = 0.007 | 0.99 |
| | (APSO) | | | | g mg⁻¹ min⁻¹ | |

*C₀ and Cₜ correspond to the TOC concentration (mg L⁻¹) at time 0 and time t (min), k₁ (min⁻¹) and k₂ (L mg⁻¹ min⁻¹) are the rate constant of MPFO and MPSO models, respectively.
**t denotes the time elapsed since the start of the experiment in minutes, qₜ represents the mg of TOC adsorbed at time t (min), qₑ (mg g⁻¹) is the max (equilibrium) adsorption capacity of SAC, and k_{ads2} (g mg⁻¹ min⁻¹) refers to the rate constant of APSO model.

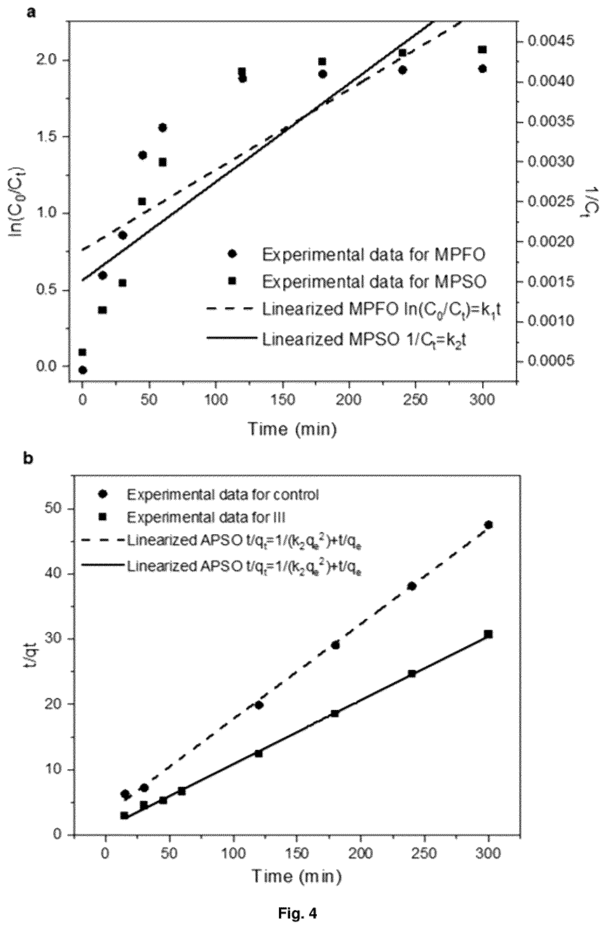

The linearized forms of the aforementioned models were analyzed and plotted in FIG. 4. Upon examination of the graphs, it is evident that the adsorption model displayed the best fit, which is corroborated by the corresponding parameters presented in Table 4, where the correlation coefficient (r²) of adsorption pseudo-second order (APSO) was greater than 0.99, unlike mineralization pseudo-second-order (MPSO) and pseudo-first-order (MPFO) with values no higher than 0.73. This implies that adsorption, rather than electrochemical mineralization, was the dominant process for TOC removal. Moreover, it was observed that the maximum adsorption capacity of SAC (qₑ) rose from 6.84 to 10.31 mg g⁻¹ when a potential was applied, i.e. an increase by 50%. This phenomenon can be attributed to the electro-adsorption and cleaning effect of the electrochemical process, which significantly enhanced the effective maximum adsorption capacity of the material.

### Example 6. Efficiency of SAC Regeneration Over Consecutive Treatment Cycles

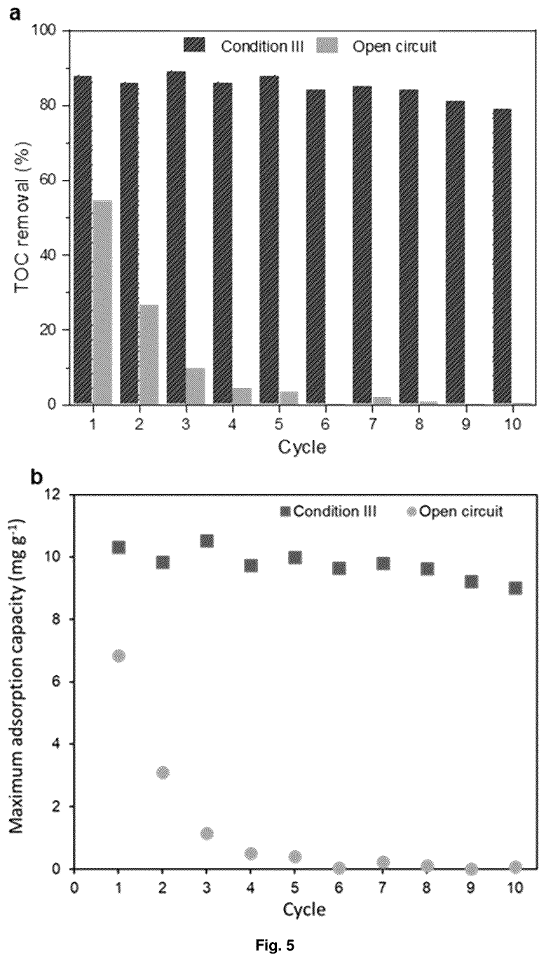

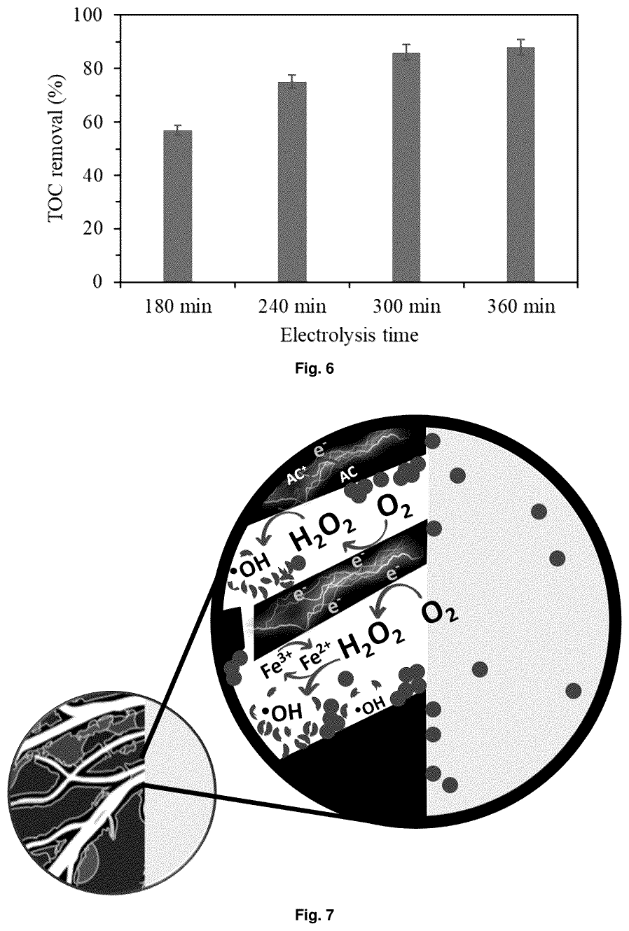

We demonstrated in Example 5 that adsorption was the predominant mechanism for the removal of TOC during the treatment of PWW. A hastened conclusion would be that the electrochemical treatment is thus redundant, if similar performance could be achieved using a superior adsorbent alone. Yet, FIG. 5a shows the crucial role that the electrical potential plays not only in achieving higher TOC removal efficiency (˜87%) compared to adsorption alone (˜54%) but also in maintaining this performance over ten consecutive cycles, each lasting 5 h. The 5 h duration was selected as the minimum time needed to recover the performance up to the initial performance of ˜87%, thus corresponding to near complete SAC regeneration (FIG. 6). In contrast, the open-circuit control deteriorated rapidly after each cycle, leading to a complete loss of adsorption capacity after only four cycles. The TOC decay over the course of 10 cycles followed an adsorption pseudo-second-order model, consistent with the findings presented in Example 4. FIG. 5b illustrates the evolution of qₑ over time, derived from the fitting to the adsorption model. As expected, a marked decline in maximum adsorption capacity was observed in open circuit conditions starting from the second cycle of treatment, whereas it was maintained at a high level upon application of an electrical current (condition III). These results demonstrate that although the TOC removal mechanism was indeed dominated by adsorption, as explained in Example 5, the simultaneous mineralization of pollutants allowed preserving the adsorption capacity of SAC over several treatment cycles.

Earlier studies on activated carbon regeneration commonly have involved a two-step procedure involving: (i) an initial pollutant adsorption; and (ii) a separate regeneration step. These sequential methodologies lead to extended treatment times, increased logistical complexities, and a necessity for intricate treatment systems. In contrast, both processes of adsorption and mineralization occur simultaneously in our system, though at different pace, which streamlines the process and reduces the treatment time, as well as the overall system complexity.

A schematic drawing summarizing the mechanisms involved in the adsorption/mineralization of pollutants taking place inside the pores of SAC and concomitant regeneration of SAC through the generation and activation of H₂O₂ is shown in SI (FIG. 7). Finally, this experiment demonstrates the excellent stability of the electrodes over time, a critical consideration for any electrochemical process. In the present disclosure, SAC proved that it is able to maintain its electrical properties and regeneration efficiency, with minimal degradation over time.

### Example 7. Identification of Degradation By-Products

Pharmaceutical industrial effluents are complex mixtures of inorganic and organic compounds, where determining the precise initial chemical composition remains a challenging and sometimes impractical task. Nonetheless, it has been widely reported that the degradation of organic compounds converts them into smaller organic molecules such as carboxylic acids, which eventually undergo complete mineralization to produce CO₂. In this sense, by monitoring the generation of carboxylic acids over time, we can confirm the findings of the previous sections that our treatment process does not solely rely on adsorption, but electrochemical mineralization is also taking place. Furthermore, the removal of AZI, the active pharmaceutical compound in the studied PWW, serves as a crucial indicator of the efficiency of our electrochemical treatment.

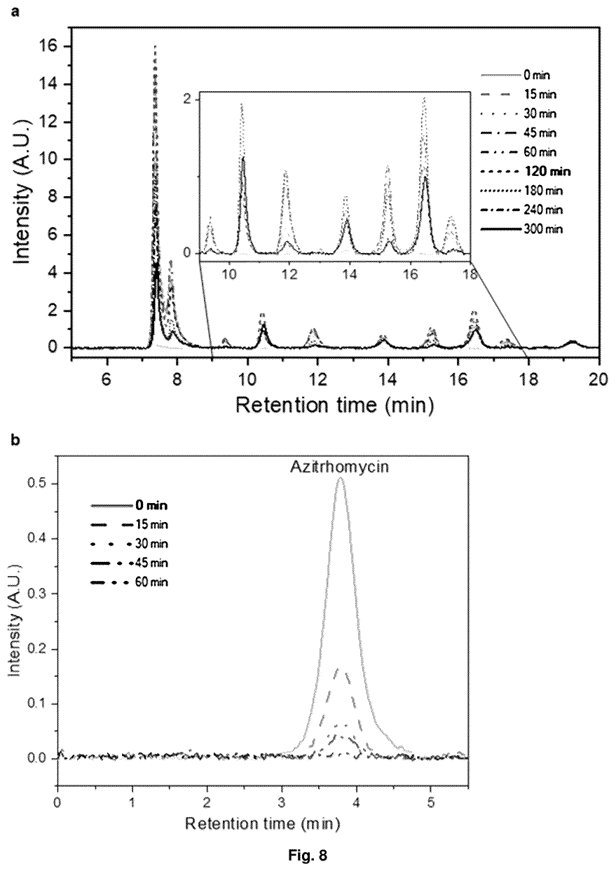

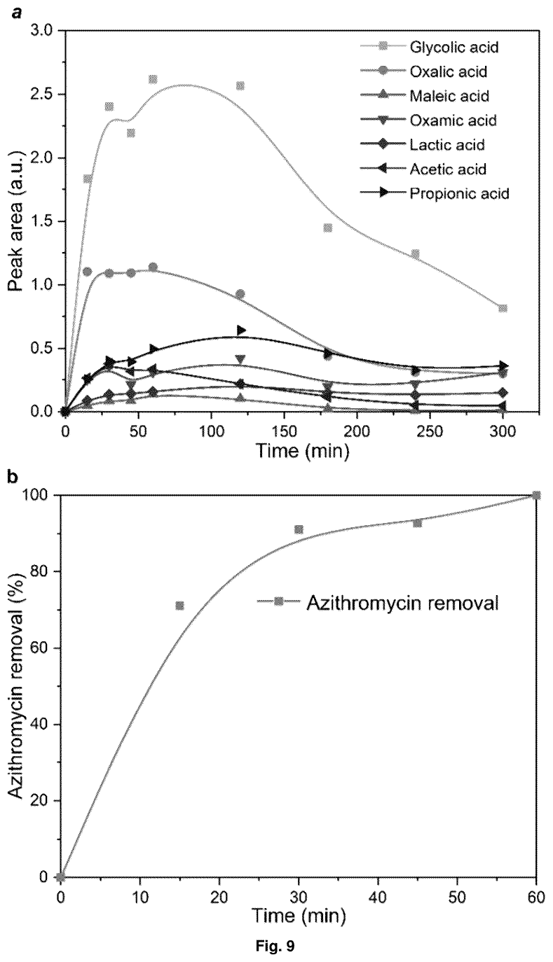

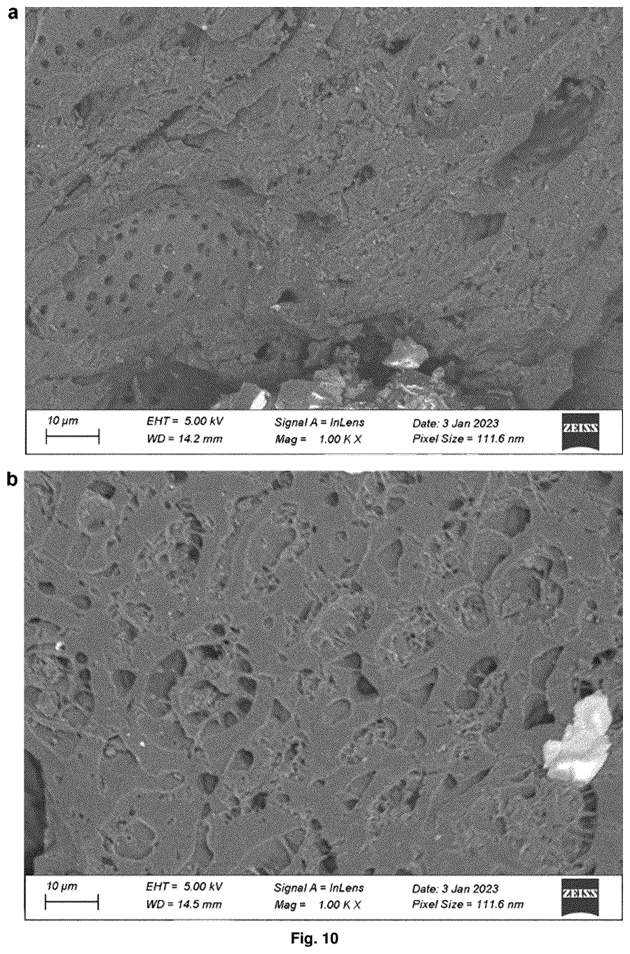

The evolution of carboxylic acids during electrochemical treatment of PWW (under condition III) is displayed in FIG. 8a. At time zero, the initial chromatogram proves that no carboxylic acids were initially present in PWW. Then, as electrolysis progressed with time, there was a marked increase in the short chain organic compounds detected, reaching peak concentrations after 25 to 100 min of treatment, followed by a decay (cf. FIG. 9a). Among the seven carboxylic acids detected, the highest peak areas correspond to glycolic and oxalic acid, whose concentrations started to decrease after 100 min of electrolysis. These results, alongside the regeneration cycles, support a two-step removal of TOC consisting of adsorption onto SAC and electrochemical oxidation, as demonstrated by the generation and subsequent removal of carboxylic acids. Moreover, complete removal of azithromycin was attained following 1 h of treatment, as depicted in FIG. 8b. The removal of this compound was shown to be particularly rapid, with 70% of its removal achieved within the first 15 min of electrolysis (cf. FIG. 9b). Overall, these findings underscore the effectiveness of our combined adsorption and electrochemical treatment approach in facilitating swift and efficient removal of pharmaceutical compounds of high molecular weight and recalcitrant nature.

### Example 8. Effect of Electrochemical Regeneration on the Physicochemical and Electrochemical Properties of SAC

The characterization of SAC before and after PWW treatment is critical for assessing changes in its properties and determining the degree of SAC regeneration taking place within the proposed system. This example thus presents the comprehensive characterization of SAC by SEM, EDX, BET, EIS, Raman spectroscopy and XRD analysis, before and after 10 cycles of electrochemical treatment process.

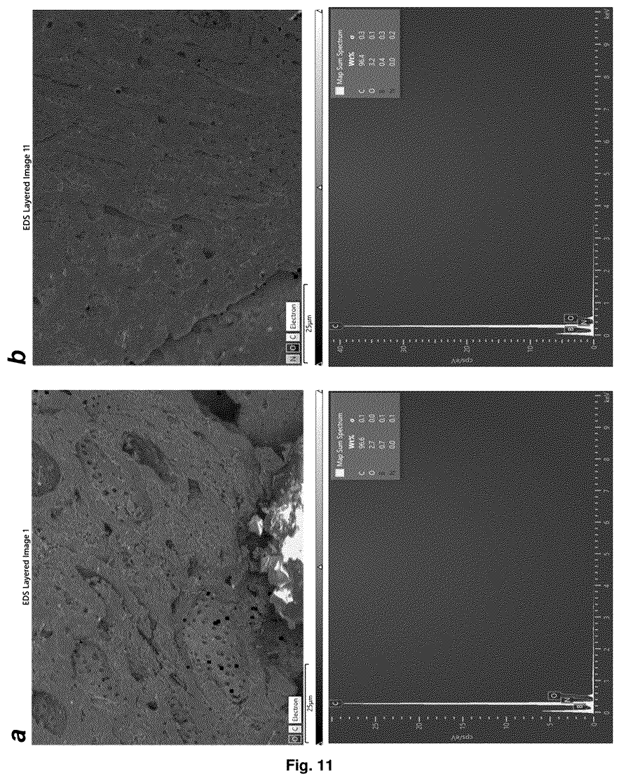

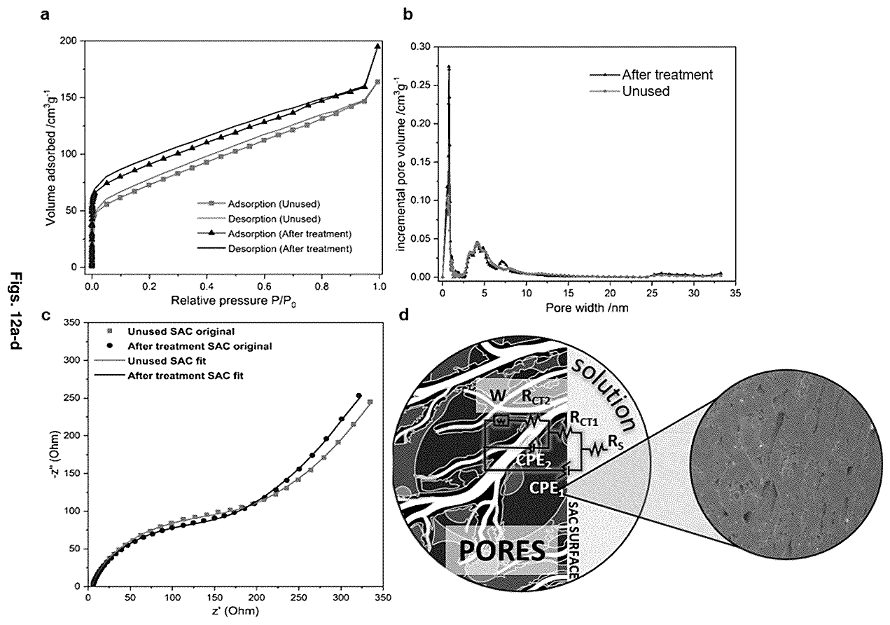

The micrographs of SAC shown in FIGS. 10a-b reveal that the diameter of the visible pores fell within the range of 0.1-3 μm with no significant change in the SAC surface morphology before and after PWW treatment, indicating that the treatment process did not alter the original structure of SAC. EDX analysis (FIG. 11) showed that, as expected, both materials were primarily composed of high concentrations of carbon with small concentrations of oxygen. It is worthy of note that the concentration of oxygen in the regenerated activated carbon was found to increase slightly, from 2.7% to 3.2%, which could be attributed to the oxidative environment in the treatment process. Nevertheless, this had little consequence on the adsorption capacity of SAC, as demonstrated earlier over multiple regeneration cycles.

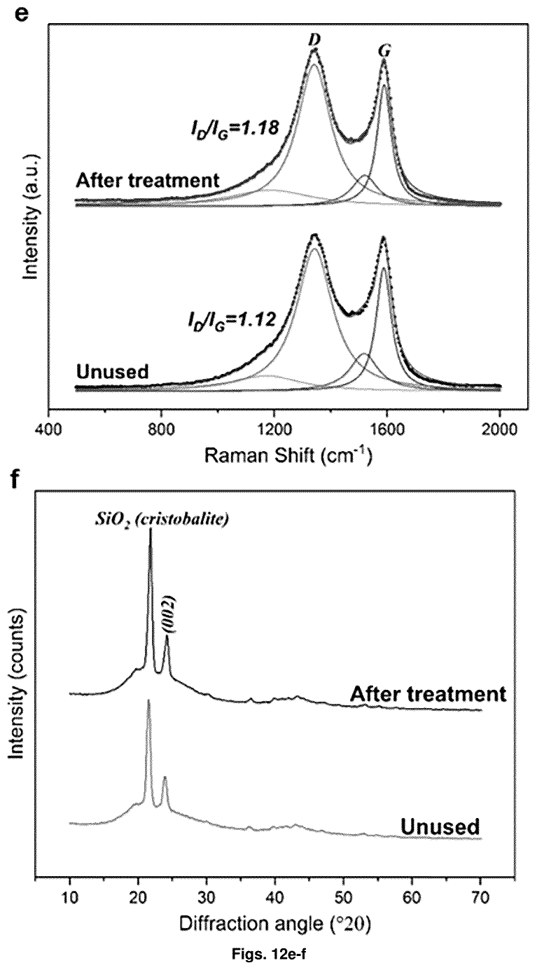

The adsorption and desorption isotherms of N₂ onto and from SAC are shown in FIG. 12a, with a characteristic H4 hysteresis loop indicative of micro-mesoporous carbon. The pore size distribution analysis (FIG. 12b) revealed a bimodal distribution of pore width, with micropores and mesopores ranging from 0.55 to 1.33 nm and from 2.6 to 10 nm, respectively. After 10 cycles of electrochemical treatment, SAC displayed a significant increase in micropore and mesopore volume, supported by an increase in surface area (252 to 327 m² g⁻¹), pore volume (0.227 to 0.256 cm³ g⁻¹), and pore width (0.723 to 0.753 nm) (Table 5). These findings confirm that in-situ regeneration successfully maintained and even enhanced the porous structure of SAC, owing to the removal of impurities that were initially present in the commercially-procured SAC during treatment.

TABLE 5
Pore characteristics of SAC before and after treatment.

| | S_{BET} | Pore volume | Average pore width |
|---|---|---|---|
| Status | (m² g⁻¹) | (cm³ g⁻¹) | (nm) |
| Unused | 252 | 0.227 | 0.723 |
| After treatment | 327 | 0.256 | 0.753 |

EIS was used to investigate the effect of PWW treatment on the electrochemical properties of SAC. Nyquist plots (FIG. 12c) showed suppressed semicircles at high frequencies and a 45° linear region at low frequencies, characteristic of electrochemical reactions on rough surfaces and diffusion-limited impedance responses, respectively (Vivier, V. & Orazem, M. E., Chem. Rev. 2022, 122, 11131-11168). The optimal equivalent circuit included an ohmic resistance (Rₛ), a Warburg impedance element (W), two charge transfer resistances (R_{ct1} and R_{ct2}), and two constant phase elements (CPE₁ and CPE₂), representing electrochemical processes on the surface, as well as within the pores, of the material (FIG. 12d). The values of the equivalent circuit components were obtained with the NOVA 2.1.5 software and are summarized in Table 6. While the Rs values for both unused and treated SAC were similar, a significant decrease was observed in charge transfer resistances (R_{ct1} and R_{ct2}) from 192 Ω to 170 Ω and from 142 Ω to 94Ω, respectively, following 10 cycles of PWW treatment. This could again be explained by the elimination of pre-existing impurities within the SAC pores, as already mentioned above. Additionally, W declined from 7.61×10⁻⁴ to 5.92×10⁻⁴ [symbol] s^{0.5} following treatment, suggesting an enhancement of ion diffusion. This is consistent with the increased average pore size observed in BET analysis, wherein larger pores may have contributed to improved diffusion capabilities in SAC.

TABLE 6
Parameters obtained from the equivalent electric circuit
fitting by electrochemical impedance spectroscopy.

| Equivalent Circuit Element | Before treatment | After treatment |
|---|---|---|
| Rₛ (Ω) | 4.80 | 5.14 |
| R_{ct1} (Ω) | 192 | 170 |
| CPE₁ ( [symbol] s ^{α}^{¹}) | 9.37 × 10 − 5 | 8.70 × 10⁻⁵ |
| α₁ | 0.814 | 0.817 |
| R_{ct2} (Ω) | 142 | 94 |
| CPE₂ ( [symbol] s ^{α}^{²}) | 1.04 × 10⁻³ | 1.08 × 10⁻³ |
| α₂ | 0.632 | 0.617 |
| W ( [symbol] s^{0.5}) | 7.61 × 10⁻⁴ | 5.92 × 10⁻⁴ |

The Raman analysis (FIG. 12e), showed two sharp bands at 1342 cm⁻¹ (D band) and 1589 cm⁻¹ (G band), where the ID/IG ratio was slightly higher than 1, indicating amorphous content with some level of crystallinity in SAC. XRD analysis (FIG. 12f), showed both SAC samples before and after PWW treatment exhibiting a clear amorphous background, with a sharp peak at 21.8°, indicating the presence of SiO₂, a common impurity most likely produced during the sintering process and a lower intensity sharp peak at around 24.1°, corresponding to the (002) plane in the SAC carbon structure, a sign of graphitization and crystallinity. In conclusion, the comprehensive characterization of SAC before and after PWW treatment substantiates that electrochemical regeneration is an efficient approach to not only sustain the physicochemical properties of SAC, but in fact augment some of these properties.

### Example 9. Energy Consumption

The energy consumption (EC) of the electrochemical process was normalized by grams of TOC removed and by volume of PWW treated, using Eqs. (11) and (12), respectively (Brillas, E., Sci. Total Environ. 2022, 819, 153102):

$${EC}_{TOC} ( kWh {g}_{T O C}^{- 1} ) = {E}_{c e l l} It / ( ( Δ TOC ) {V}_{S} ) \qquad ( 11 )$$

$${EC}_{VOL} ( kWh {m}^{- 3} ) = {E}_{c e l l} It / {V}_{S} \qquad ( 12 )$$

Where E_{cell} stands for the potential applied during electrolysis (V), I is the resulting current (A), t is the treatment time (h), ΔTOC corresponds to the TOC removed (mg L⁻¹) and V_{S} is the volume of wastewater (L).

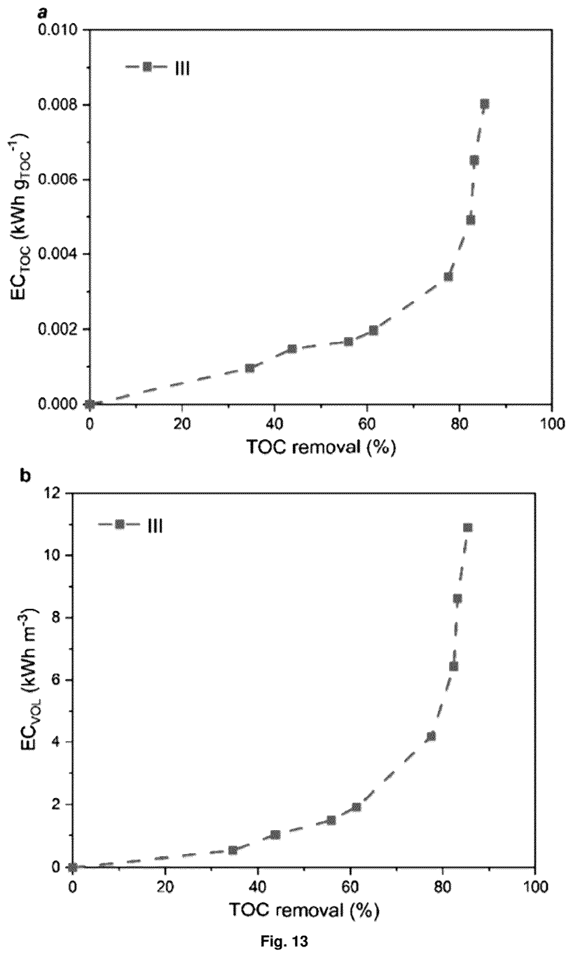

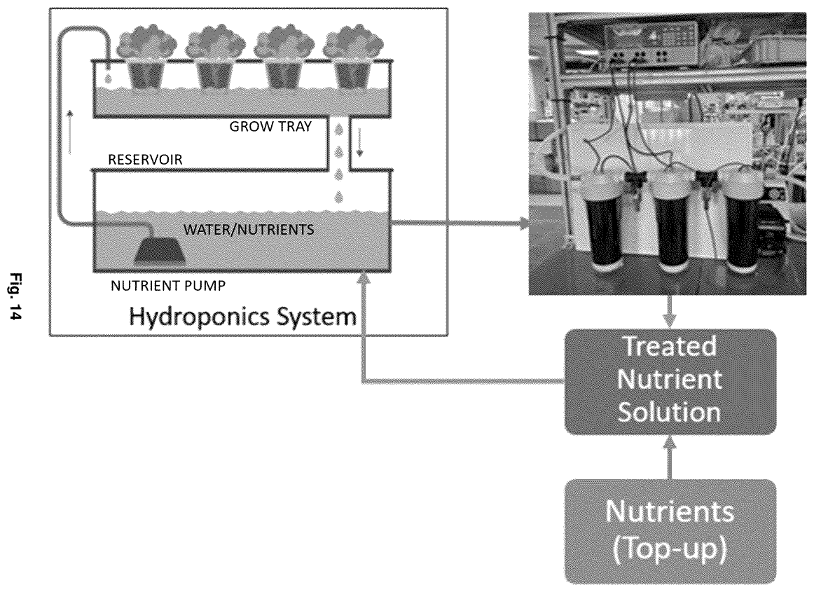

The results presented in FIG. 13 offer valuable insights into the energy efficiency of the electrochemical treatment process. First, the EC of the process remained relatively low until the removal of TOC exceeded 70%, at which point there was a sharp increase. This observation suggests progressive saturation of SAC, alongside the formation of more recalcitrant degradation products that are less reactive to hydroxyl radicals over time. By comparing EC in terms of grams of TOC removed (FIG. 13a) and treated volume of PWW (FIG. 13b), we justify the high apparent volumetric energy requirement by the high initial TOC concentration of the real PWW used in the present disclosure (1625 mg L⁻¹) and in fact the electrochemical process was found to be highly efficient for the treatment of high initial organic concentrations. It is also worthy of note that the use of catalytic amounts of Fe(II) as the sole chemical input under condition (III) (with no electrolyte added, as well as no acid and/or base) may reduce the costs associated with chemical usage, as well as eliminate the need for sludge disposal.

Table 7 summarizes the EC and corresponding max TOC removal of different treatment processes for PWW previously reported in the literature. Where EC_{TOC} and EC_{VOL} was not directly reported, we calculated it following Eqs. (11) and (12), using the information reported in the respective papers. First, it is worthy of note that the present invention treated the highest initial TOC concentration and deals with real PWW. The much higher TOC concentration compared to the other works of Table 7 obviously resulted in moderate performance in terms of EC_{VOL}; in contrast, EC_{TOC} was remarkably low (8.0×10⁻³ kWh g_{TOC}⁻¹), despite the challenges of treating real PWW. This observation shows that EC_{TOC} is arguably a better indicator than EC_{VOL} when treating PWW, as the initial TOC in different samples can vary across several orders of magnitude, from as low as 0.6 mg L⁻¹ (Cano, P. A. et al., Emerg. Contam. 2020, 6, 53-61) to as high as 1625 mg L⁻¹ (the present disclosure). Further, SAC improves the AC particle contact and thus the conductivity, while maintaining optimal liquid flow. In summary, these results demonstrate that the adsorptive enrichment of pollutants in SAC significantly increased the energy efficiency of our electrochemical treatment process by improving the utilization of hydroxyl radicals generated in close proximity at the SAC cathode, so that hydroxyl radicals were not wasted in parasitic reactions.

TABLE 7
Mineralization and EC comparison of different processes
for the treatment of synthetic and real PWW.

| | TOC | | | | |
|---|---|---|---|---|---|
| Initial TOC | removal | Energy | Energy | | |
| concentration | (treatment | Consumption | Consumption | Treatment | |
| (mg L⁻¹) | time) | (kWh g_{TOC}⁻¹) | (kWh m⁻³) | process | Refs. |
| 0.6 | 47.0% | 137 | 38.7 | UV/H₂O₂ | Cano, P. A. et |
| (Azithromycin) | (120 min) | | | | al., |
| | | | | | Emerg. Contam. |
| | | | | | 2020, 6, 53-61 |
| 38.8 (real | 15.0% | 10.5 | 61.1 | Photo-Electro- | Martínez- |
| PWW mixture) | (180 min) | | | Fenton | Pachón, D. et |
| | | | | Process | al., Sci. Total |
| | | | | | Environ. 2021, |
| | | | | | 772, 144890 |
| 41.9 | 73.3% | 13.9 | 427 | Electro- | Leili, M. et al., |
| (Cephalexin) | (70 min) | | | oxidation | J. Mol. Liq. |
| | | | | Process | 2020, 313, 113556 |
| 26.3 | 48.6% | 0.400 | 5.11 | Electro- | Kaur, R. et al., |
| (Amoxicillin) | (240 min) | | | catalytic | Electrochim. |
| | | | | Oxidation | Acta 2019, 296, |
| | | | | Process | 856-866 |
| 24.3 | 99% | 2.00 | 48.1 | Classical | Yang, W. et al., |
| (Imatinib) | (480 min) | | | Electro-Fenton | Electrochim. |
| | | | | | Acta 2019, 305, |
| | | | | | 285-294 |
| 30.0 | 63% | 0.0432 | 0.816 | Surface- | Guo, H. et al., |
| (Norfloxacin) | (120 min) | | | reconstructed | Environ. Res. |
| | | | | graphite felt | 2023, 220, |
| | | | | cathode, | 115221 |
| | | | | Electro-Fenton | |
| 3.0 (simulated | 72.9% | 0.00110 | 0.00240 | Graphene- | Lu, W. et al., |
| antibiotic | (120 min) | | | based cathode, | Chem. Eng. J. |
| wastewater) | | | | heterogeneous | 2023, 468, |
| | | | | Electro-Fenton | 143780 |
| 11.1 (synthetic | 83% | 0.116 | 1.07 | Fe—N—C catalyst | Qian, M. et al., |
| antibiotic | (120 min) | | | coated carbon | Appl. Surf. Sci. |
| wastewater) | | | | felt cathode, | 2023, 609, |
| | | | | Electro-Fenton | 155310 |
| 1625 (real | 87% | 0.00800 | 11.3 | Simultaneous | The present |
| PWW with | (300 min) | | | SAC | disclosure |
| Azithromycin) | | | | adsorption + | |
| | | | | EF | |
| | | | | regeneration | |
| | | | | Process | |

### Example 10. Treatment of Spent Nutrient Solution Using Electro-Oxidation

Electrochemical oxidation as a modular and green treatment method to reuse and recover the spent nutrient solution in hydroponic farms was investigated.

### Experimental Setup

As shown in FIG. 15, there is an experimental setup 1500 that includes a power supply 1510, an anode 1520, a cathode 1530, and an air supply 1540. The anode 1520 may be a DSA or a boron dope diamond (BDD) anode. The cathode 1530 may be a carbon-fibre brush (CFB) or an activated carbon (AC).

### Method for Determining Concentration of Coliforms

The concentration of coliforms may be determined by following the protocol in Introduction. 9221B. Standard Total Coliform Fermentation Technique 9221C, Standard Methods Online—Standard Methods for the Examination of Water and Wastewater.

### Method for Determining Concentration of Phosphate

Instrument: DR 6000 HACH UV-spectrophotometer
Measurement range: 0.1-1.0 mg/L Procedure:
   1. Prepare blank sample: add 5 mL deionised (DI) water into an empty COD vial.
   2. Prepare sample: add 5 mL sample to another empty COD vial (usually sample will be diluted. Take note of the dilution times and then add the sample and DI water accordingly).
   3. Add 0.2 mL ascorbic acid and 0.4 mL color reagent to each COD vial, then tighten the cap onto the tube.
   4. Shake the tube 2˜3 times to mix the liquid and start the reaction time of 15 minutes.
   5. Clean the vial using Kimwipes, select the program named ‘PO4_P’ (PO4-P) to measure the phosphate concentration.
   6. Note: Use the blank to zero first and then measure the sample.

### Method for Determining Concentration of Total Phosphorus (TP)-Lab Method

Instrument: DR 6000 HACH UV-spectrophotometer
Measurement range: 0.1-1.0 mg/L
Procedure:
   1. Turn on the digestion block and preheat to 120° C.
   2. Prepare Blank Sample: add 4.3 mL DI water into an empty COD vial.
   3. Prepare Sample: add 4.3 mL sample to another empty COD vial (usually sample will be diluted. Take note of the dilution times and then add the sample and DI water accordingly (The calculation should be using total volume of 5 mL instead of 4.3 mL).
   4. Add 0.7 mL oxidization reagent (K2S2O8) to each COD vial, then tighten the cap onto the tube.
   5. Shake the tube 2˜3 times and insert the vial in the preheated digester.
   6. Allow the vial to digest in the digestion block for 0.5 hour, then carefully remove the vial from the digester and let the vial cool to room temperature.
   7. Mix the content in the vial again for 2-3 times and add 0.2 mL ascorbic acid and 0.4 mL color reagent to each COD vial, then tighten the cap onto the tube.
   8. Shake the tube 2˜3 times to mix the liquid and start the reaction time of 15 minutes.
   9. Clean the vial using Kimwipes, select the program named TP to measure the total phosphate concentration. (Note: Use the blank to zero first and then measure the sample.)
      Method for Determining Concentration of Nitrite-Nitrogen (NO₂⁻—N)
Instrument: DR 6000 HACH UV-spectrophotometer
Measurement range: 0.002-0.1 mg/L (Low Range)
Procedure:
   1. Prepare blank sample: add 5 mL DI water into an empty Chemical Oxygen Demand (COD) vial.
   2. Prepare sample: add 5 mL sample to another empty COD vial (usually sample will be diluted. Take note of the dilution times and then add the sample and DI accordingly).
   3. Add 0.2 mL color reagent to each COD vial, then tighten the cap onto the tube.
   4. Shake the tube 2˜3 times to mix the liquid and start the reaction time of 20 minutes.
   5. Clean the vial, select the program named ‘Nitrite_LR’ to measure the nitrite concentration
   6. Note: Use the blank to zero first and then measure the sample
      Method for Determining Concentration of Nitrate-Nitrogen (NO₃⁻—N)
Instrument: DR 6000 HACH UV-spectrophotometer
Measurement range: 0.1-10.0 mg/L
Procedure:
   1. Prepare blank sample: add 10 mL DI water into a 15 mL centrifuge tube. (makeup −10 mL)
   2. Prepare sample: add 10 mL sample into the 15 mL centrifuge tube (usually sample will be diluted. Take note of the dilution times and then add the sample and DI water accordingly).
   3. Add 0.2 mL 1 M HCl to each centrifuge tube, then tighten the cap on the tube.
   4. Shake the tube 2-3 times to mix the content and react for 25 minutes.
   5. Use 2Q cuvette to measure the nitrate concentration (please make sure the labeled 2Q of the cuvette is in your front)
   6. Select the program named ‘20171018 NO3-N HSJ’ to measure the nitrate (please use DI water to wash the cuvette after every sample and rinse it with the sample prior to addition of sample into the cuvette, Wipe the outer surface using the Kimwipes.) (Note: Use the blank to zero first and then measure the sample)

### Results and Discussion

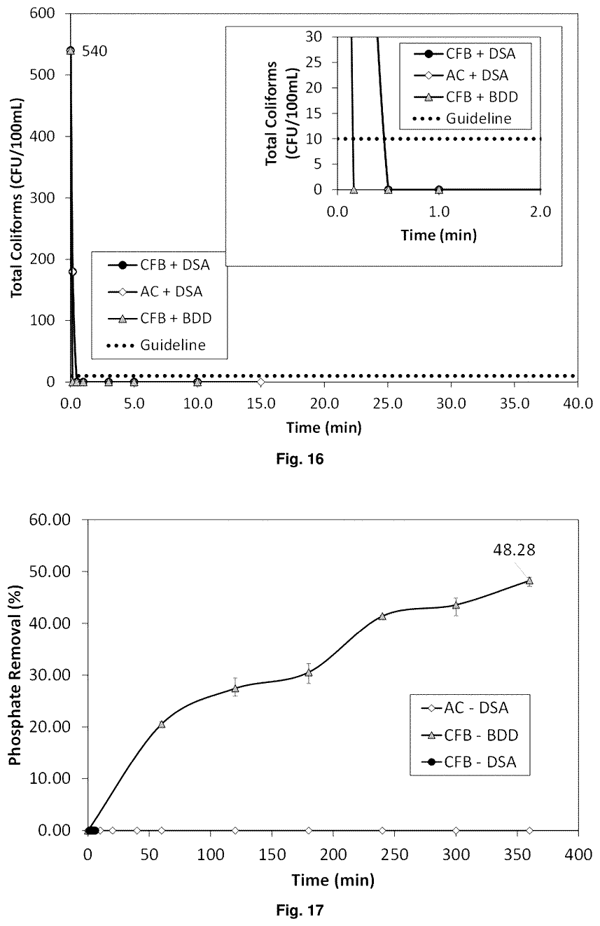

### Coliform Removal Efficiency (%) (FIG. 16)

1) Setup with AC+DSA:

Total coliforms was reduced to the water reuse guideline* of <10 CFU/100 mL by 0.5 min (initial at 540 CFU/100 mL).

2) Setup with CFB+DSA:

Similar performance as AC+DSA.

3) Setup with CFB+BDD:

Total coliforms was reduced to the water reuse guideline* of <10 CFU/100 mL by 10s (initial at 540 CFU/100 mL).

### TOC Removal

Corresponding TOC removal for different electrode pairs:
1) AC+DSA: 70.54±3.03%;
2) CFB+BDD: 53.63±0.66%; and
3) CFB+DSA: 36.02±3.52%.

AC was the best cathode overall based on coliform and organic removal.

Phosphate with Various Electrode Pairs (FIG. 17)

PO₄³⁻ present in the reacting solution was oxidized to form P₂O₈⁴⁻ when BDD was used as an anode due to excessive oxidation. Whereas with DSA, PO₄³⁻ was not oxidized. P₂O₈⁴⁻ does not have any benefits to plant growth thus DSA is the best anode (and it is also cheaper than BDD).

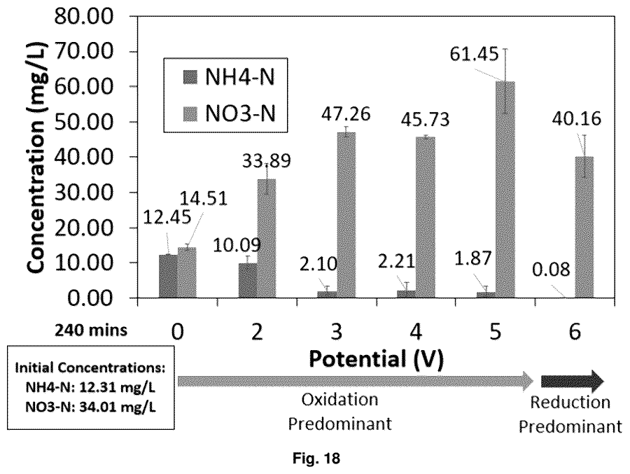

Nitrogen Species Under Various Potentials with AC-DSA (FIG. 18)

The fate of nitrogenous species (NH₄—N and NO₃—N) varied with the applied potential.

At potentials (1-5V):

NH₄ was predominantly oxidized to NO₃

NH₄+O₂→NO₂→NO₃

### At Potential of 6V:

NO₃—N was further reduced to N₂ (and thus lost)

NO₃→NO₂×NO→N₂

Electrochemical treatment of spent nutrient solution is promising to enable water reuse in hydroponics systems. With the best combination of electrodes (CFB-DSA), total coliform removal was achieved within a minute of treatment. Nutrients in the form of phosphate, NH₄⁺ and NO₃⁻ can be retained. This sets up a good basis to incorporate electro-oxidation in hydroponics systems.

### Comparative Example 1

SAC improves the AC particle contact and thus the conductivity, while maintaining optimal liquid flow.

TABLE 8
Comparison of loose granular activated
carbon (GAC) and SAC electrodes.

| | | Total organic | | | |
|---|---|---|---|---|---|
| | | carbon (TOC) | | | |
| | Wastewater | removal | | Energy | |
| Electrode | tested on | (over time) | | consumption | |
| GAC | Synthetic | 22 | mg of TOC/ h | 600 | Wh/kg of AC |
| | phenol solution | | | | |
| | (TOC₀ = | | | | |
| | 720 mg/L) | | | | |
| SAC | Real pharma | 84 | mg of TOC / h | 15 | Wh/kg of SAC |

(TOC₀ =
1625 mg/L)

### CONCLUSION

In the present disclosure, a system that combines the adsorption and degradation/mineralization of organics on SAC, alongside its simultaneous in-situ electrochemical regeneration, is demonstrated. SAC involves the fusion or bonding of AC particles using high heat and pressure, resulting in a consolidated, monolithic structure with a highly porous nature. This structural alteration sets SAC apart from GAC, offering enhanced rigidity and durability. To the best of our knowledge, this is the first report of using SAC for adsorption/mineralization of pollutants and its simultaneous in-situ electrochemical regeneration. The application of SAC to a real pharmaceutical effluent with high concentration of AZI represents an innovative solution and an alternative to incineration, which could result in significant cost savings for pharmaceutical companies, and could also positively impact other industrial sectors facing the challenge of high-load and hard-to-treat wastewater (e.g., in the chemical or electronics sectors).

This present disclosure demonstrates that the combination of simultaneous adsorption and in-situ electrochemical treatment of sintered activated carbon is a highly effective solution for real PWW with high initial organic load. Through careful optimization of operational parameters and a comprehensive investigation into system versatility under unadjusted pH and electrolyte conditions, several key conclusions can be drawn:
the proposed SAC adsorption process, operating concurrently with in-situ electrochemical regeneration, showcased substantial TOC removal, even without pre-conditioning;
the excellent TOC removal achieved by SAC was maintained over multiple treatment cycles, owing to its in-situ electrochemical regeneration, unlike pure adsorption processes that typically display a rapid decrease in adsorption capacity;
the present disclosure also showed that the removal of organics was not merely due to SAC adsorption, but in fact consisted of a simultaneous process of adsorption and electrochemical mineralization. To the best of our knowledge, the present disclosure constitutes the first report of simultaneous wastewater treatment and AC regeneration, which has direct implications in terms of enhancing treatment performance, ensuring stable operation over time, and eliminating cleaning downtimes;
the textural and electrochemical properties of SAC, as well as its maximum adsorption capacity, were not only maintained but even improved after regeneration;
the extremely low energy consumption observed in the present disclosure in comparison to other treatment methods previously reported in the literature showcases the relevance of this novel approach for practical applications; and
the robustness of the process enables the electrochemical treatment of effluents with unfavorable characteristics, such as low conductivity or alkaline pH. This underscores the potential of integrating this approach as part of an overall PWW management system, especially for hard-to-treat and high-load waste streams.

1. A reactor for removing a contaminant from a fluid, the reactor comprising:
a cathode comprising a sintered activated carbon filter; and
an anode.

2. The reactor of claim 1, wherein the cathode is configured to simultaneously function as a cathode and a filter.

3. The reactor of claim 1, wherein the anode is formed of boron doped diamond or a dimensionally stable anode.

4. The reactor of claim 1, further comprising a housing comprising an inlet and an outlet for the passage of a fluid through the reactor, wherein the cathode and anode are disposed within the housing.

5. The reactor of claim 1, wherein at least one of the cathode and anode have a hollow cross section.

6. The reactor of claim 1, wherein at least one of the cathode and anode has tubular structure having an outer surface and an inner surface, the inner surface defining a lumen.

7. The reactor of claim 6, wherein:
(ai) the anode has a tubular structure having an outer surface and an inner surface, the inner surface defining a lumen, and the cathode is disposed within the lumen of the anode; or
(aii) the cathode has a tubular structure having an outer surface and an inner surface, the inner surface defining a lumen, and the anode is disposed within the lumen of the cathode.

8. The reactor of claim 1, wherein the anode and cathode each have a substantially circular cross section.

9. The reactor of claim 1, wherein the cathode and anode are physically separated from each other by a distance of from about 0.1 cm to about 5 cm.

10. The reactor of claim 1, wherein one or more of the following apply:
(bi) the sintered activated carbon filter has an average pore size of from about 0.1 μm to about 3 μm;
(bii) the sintered activated carbon filter has a bimodal distribution of pore width, with micropores having a pore width of from about 0.5 nm to about 1.5 nm and mesopores have a pore width of from about 2 nm to about 15 nm;
(biii) the sintered activated carbon filter has a surface area of at least about 200 m²/g⁻¹ (BET);
(biv) the sintered activated carbon filter has an average pore volume of from about 0.2 cm³ g⁻¹ to about 0.4 cm³ g⁻¹; and/or
(bv) the anode and cathode are each electrically connectable to a power source.

11. An apparatus for removing a contaminant from a fluid, the apparatus comprising at least one reactor according to claim 1, the inlet of the at least one reactor being in fluid communication with a fluid source containing one or more contaminants, a power supply connected to the cathode and anode, and a receptacle in fluid communication with the outlet of the one or more reactors.

12. The apparatus of claim 11, wherein the fluid source is a water source.

13. The apparatus of claim 11, wherein the fluid source is a gas source.

14. The apparatus of claim 11, wherein the one or more contaminants are selected from the group consisting of an organic compound, an inorganic compound, a heavy metal, and a pathogen.

15. A method of removing a contaminant from a fluid, said method comprising
supplying the apparatus of claim 11 with a fluid comprising at least one contaminant such that the fluid enters through an inlet of the at least one reactor and is subjected to an electrochemical advanced oxidation process to remove the contaminant, such that the fluid passing through an outlet of the one or more reactors is a decontaminated fluid that has substantially none of the at least one contaminant present.

16. The method according to claim 15, wherein the at least one contaminant is adsorbed on to the sintered activated carbon filter and undergoes electrochemical treatment.

17. The method according to claim 15, wherein the fluid comprising at least one contaminant is continuously supplied to the apparatus.

18. The method according to claim 15, wherein the sintered activated carbon filter is continuously regenerated by the electrochemical advanced oxidation process.

19. The method according to claim 15, wherein the method does not comprise a step of adding an electrolyte to the fluid comprising at least one contaminant.

20. The method according to claim 15, wherein one or more of the following apply:
(ci) the method comprises adding potassium sulphate, iron (II) sulfate, or a mixture thereof to the fluid comprising at least one contaminant;
(cii) the fluid is continuously supplied to the apparatus at a flow rate of from about 5 mL/min to about 40 mL/min;
(ciii) the electric potential applied to the cathode and anode is from about 3V to about 6V;
(civ) the electrochemical advanced oxidation process is an electro-Fenton process; and/or
(cv) the electrochemical regeneration cycle of the regeneration step is conducted for a period of from about 10 seconds to about 180 minutes.
